(19) United States
(12) Patent Application Publication
(10) Pub. No.: US 2012/0308328 A1
(43) Pub. Date: Dec. 6, 2012

(54) FASTENING TOOL

(75) Inventor: Taeko Ueno, Yokohama-shi (JP)

(73) Assignee: NIFCO INC., Yokohama-shi, (JP)

(21) Appl. No.: 13/577,540

(22) PCT Filed: Feb. 7, 2011
(86) PCT No.: PCT/JP2011/052546

§ 371 Date: Aug. 21, 2012

(30) Foreign Application Priority Data
Feb. 10, 2010 (JP) 2010-028217

(51) Int. Cl. F16B 37/04

(52) U.S. Cl. 411/134

(57) ABSTRACT

A fastening tool includes a nut having a short side that is shorter than a width of an opening portion, and a long side that is longer than the width of the opening portion, and at a mounting position in which the short side corresponds to a short side of the base portion, the nut is inserted into a hollow portion inside a structure (for example, a C-shaped steel). A male screw portion (for example, a bolt), which has been inserted from the opening portion, is screwed into the nut, and also the nut rotates inside the hollow portion, so that the nut reaches a fixed position which cannot be pulled out from the opening portion, and is fixed into the hollow portion through the male screw portion (for example, the bolt). The base portion includes a temporary fixing claw temporarily fixing the nut in the mounting position.

### FIELD OF TECHNOLOGY

The present invention relates to a fastening tool for fixing a mating member such as a solar cell module or the like to a structure such as a long C-shaped steel or the like which is placed in, for example, a roof, and after inserting a base portion, in which a nut has been temporarily fixed, from an opening portion of the structure, a male screw portion, which has been inserted from the opening portion, is screwed into the nut so as to allow the nut to rotate in a fixed position wherein the nut cannot be pulled out from the opening portion.

### BACKGROUND ART

Conventionally, there is well-known a fastening tool in which a screw is screwed into the nut so as to rotate the nut, and to retain a panel from an opening portion of the panel, so that a component is fixed relative to the panel (for example, see Patent Documents 1 to 3).

### PRIOR ART DOCUMENTS

### Patent Documents

Patent Document 1: Japanese Patent No. 2576880

Patent Document 2: Japanese Unexamined Utility Model Publication No. S62-196920

Patent Document 3: Japanese Examiner Utility Model Publication No. H08-008334

### SUMMARY OF THE INVENTION

### Problems to be Solved by the Invention

In the aforementioned conventional fastening tool, however, when the nut has been unnecessarily rotated due to a vibration, an impact, and the like during transportation or at a time of mounting, the nut cannot pass through the opening portion of the panel, so that whenever the nut cannot pass through the opening portion of the panel, it is necessary to return the nut to original state and rotate the nut to have a problem of requiring labor and time for the mounting.

Thus, the present invention is made in view of the problems in which the aforementioned conventional technology has, and an object of the present invention is to allow the nut to rotate in the fixed position in which the nut cannot be pulled out from the opening portion by screwing the male screw portion, which has been inserted from the opening portion, into the nut after inserting the base portion, in which the nut has been temporarily fixed, from the opening portion of the structure.

### Means for Solving the Problems

The present invention is made in order to achieve the aforementioned object, and the present invention has the following characteristics.

First, the present invention is a fastening tool for fixing a mating member (for example, a solar cell module) to a structure (for example, a C-shaped steel) with a cross-sectional surface of an approximately C shape.

Secondly, the fastening tool comprises a base portion which is inserted from an opening portion of the structure (for example, the C-shaped steel), and a nut movably supported in the base portion, and including a female screw portion in an inner circumference.

Thirdly, the nut is formed to have a short side that is shorter than a width of the opening portion, and a long side that is longer than the width of the opening portion.

In addition to that, in a mounting position wherein the short side corresponds to a short side of the base portion, the nut is inserted into a hollow portion inside the structure (for example, the C-shaped steel) by inserting the base portion from the opening portion.

Moreover, a male screw portion (for example, a bolt), which has been inserted from the opening portion, is screwed into the nut, and also the nut rotates inside the hollow portion, so that the long side intersects with the opening portion. Accordingly, the nut reaches a fixed position which cannot be pulled out from the opening portion, and is fixed into the hollow portion through the male screw portion (for example, the bolt).

Fourth, the base portion comprises a temporary fixing claw temporarily fixing the nut in the mounting position.

The present invention may also have the following characteristic.

The temporary fixing claw is an elastic claw. In that case, by using elasticity of the temporary fixing claw, the nut can be temporarily fixed in the mounting position easily and rapidly.

The present invention may also have the following characteristic.

Between the base portion and the nut, there is provided a cam slope face which rotates the nut inside the hollow portion of the structure (for example, the C-shaped steel) when the nut has moved in an axial direction of the male screw portion (for example, the bolt) by screwing the male screw portion (for example, the bolt). In that case, by using the cam slope face, the nut can be rotated by screwing the male screw portion when the nut has been moved in the axial direction of the male screw portion.

The present invention may also have the following characteristic.

On an outside surface of the base portion, there is provided a locking claw locking in an opening edge of the opening portion of the structure (for example, the C-shaped steel). In that case, the locking claw can prevent the base portion from escaping from the opening portion of the structure. Also, by elastically abutting the locking claw against the opening edge of the opening portion, the base portion can be prevented from moving into the hollow portion of the structure, i.e., in a longitudinal direction of the structure.

The present invention may also have the following characteristic.

In the base portion, in a state wherein the base portion is inserted into the hollow portion of the structure (for example, the C-shaped steel), there is provided an operation grip facing the opening portion. In that case, by using the operation grip, the base portion can be moved into the hollow portion of the structure, i.e., in the longitudinal direction of the structure.

### Effect of the Invention

Since the present invention is structured as mentioned above, the present invention has the following effect.

After inserting the base portion, in which the nut has been temporarily fixed, from the opening portion of the structure, the male screw portion, which has been inserted from the opening portion, is screwed into the nut so as to be capable of rotating the nut in the fixed position wherein the nut cannot be pulled out from the opening portion.

Namely, by temporarily fixing the nut in the mounting position using the temporary fixing claw, the present invention can prevent the nut from rotating unnecessarily in the fixed position.

### BRIEF DESCRIPTION OF THE DRAWINGS

FIG. 1 is a perspective view of a fastening tool according to the first embodiment of the present invention.

FIG. 2 is an exploded perspective view for explaining an attaching position of the fastening tool, and is a partially perspective view for explaining an attaching state of a support clasp.

FIG. 3 is an exploded perspective view for explaining the attaching state of the fastening tool.

FIG. 4 is an exploded perspective view of the fastening tool.

FIG. 5 is a perspective view for explaining the attaching state of the fastening tool.

FIG. 6 is a front view of a base portion according to the first embodiment of the present invention.

FIG. 7 is a back view of the base portion.

FIG. 8 is a plan view of the base portion.

FIG. 9 is a bottom view of the base portion.

FIG. 10 is a left side view of the base portion.

FIG. 11 is a right side view of the base portion.

FIG. 12 is a cross-sectional view for explaining the attaching state of the fastening tool.

FIG. 13 is a cross-sectional view taken along line A-A in FIG. 12.

FIG. 14 is a cross-sectional view for explaining a state in which a bolt is screwed in the first embodiment of the present invention.

FIG. 15 is a cross-sectional view taken along line B-B in FIG. 14.

FIG. 16 is a perspective view wherein one portion of the fastening tool is enlarged for explaining a rotating state of the nut.

FIG. 17 is a perspective view of the fastening tool for explaining a second embodiment of the present invention.

FIGS. 18(a) to 18(c) are perspective views of the nut for explaining a third embodiment of the present invention.

FIG. 19 is a perspective view of the fastening tool for explaining a fourth embodiment of the present invention.

FIG. 20 is a cross-sectional view of the attaching state of the fastening tool for explaining the fourth embodiment of the present invention.

### BEST MODES OF CARRYING OUT THE INVENTION

### Fastening Tool 10

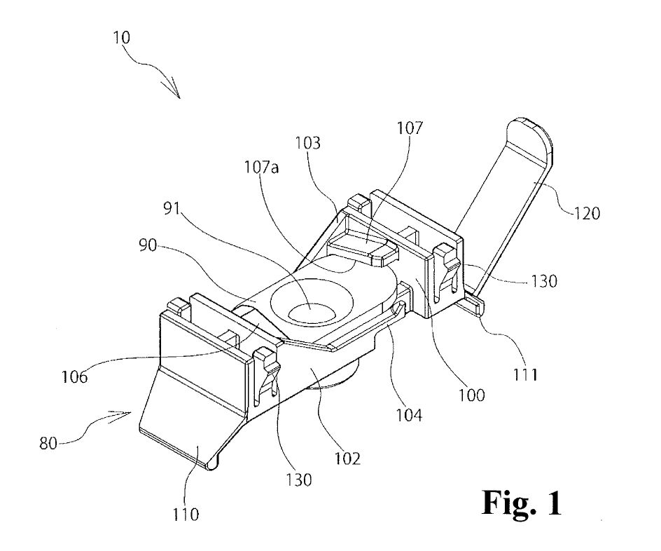

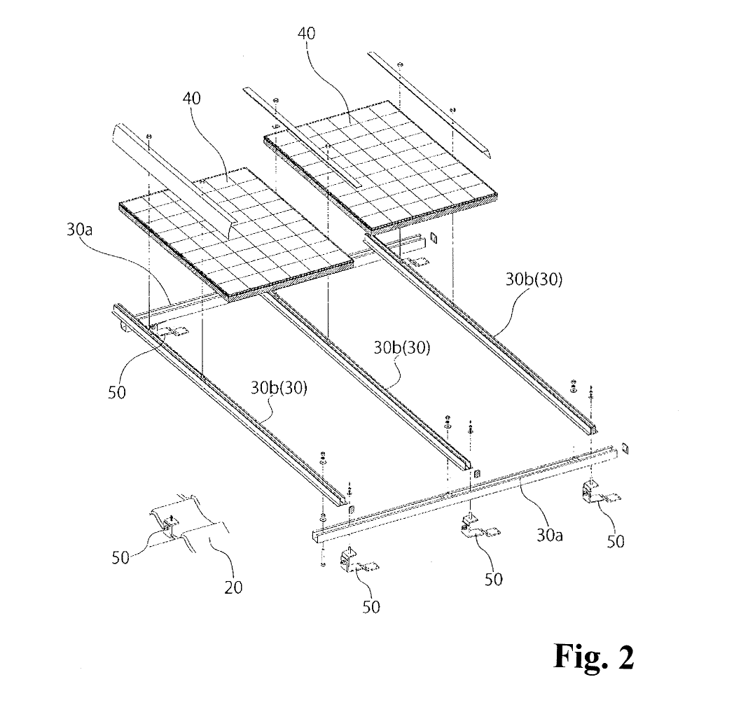

In FIG. 1, the reference numeral 10 represents a fastening tool, and as shown in FIG. 2, the fastening tool 10 is for fixing mating members such as solar cell modules 40 or the like to structures such as long C-shaped steels 30 or the like which are placed in, for example, a roof (a tile 20).

Specifically, as shown in FIG. 2, a plurality of support clasps 50 is attached to the tile 20, and a plurality of vertical bars 30a is fixed relative to the support clasps 50 by crossing the vertical bars 30a, and furthermore, a plurality of transverse bars 30b which is the C-shaped steels 30 is fixed relative to the vertical bars 30a by crossing the transverse bars 30b. Lastly, by using the fastening tool 10, a plurality of the solar cell modules 40 is fixed relative to the transverse bars 30b by crossing the solar cell modules 40.

Incidentally, although the vertical bars 30a are fixed to the tile 20 through the support clasps 50, they are not limited to the above, and although it is not shown in the figures, by using, i.e., a support tile in which the support clasps are fixed, the vertical bars 30a may be fixed relative to the support tile. Also, although a roof using a tile 20 is illustrated as an example, it is not limited to the above, and although it is not shown in the figures, a roof without using the tile 20 may be used.

Moreover, by combining the vertical bars 30a and the transverse bars 30b, the solar cell modules 40 are fixed. However, only one of the vertical bars 30a or the transverse bars 30b may be used.

Also, as an attaching position of the solar cell modules 40, the roof (the tile 20) is illustrated as an example; however, it is not limited to the above. Also, as the mating members, the solar cell modules 40 are illustrated as an example; however, they are not limited to the above, and may be a solar heat collector, greening facilities, a signboard, and the like.

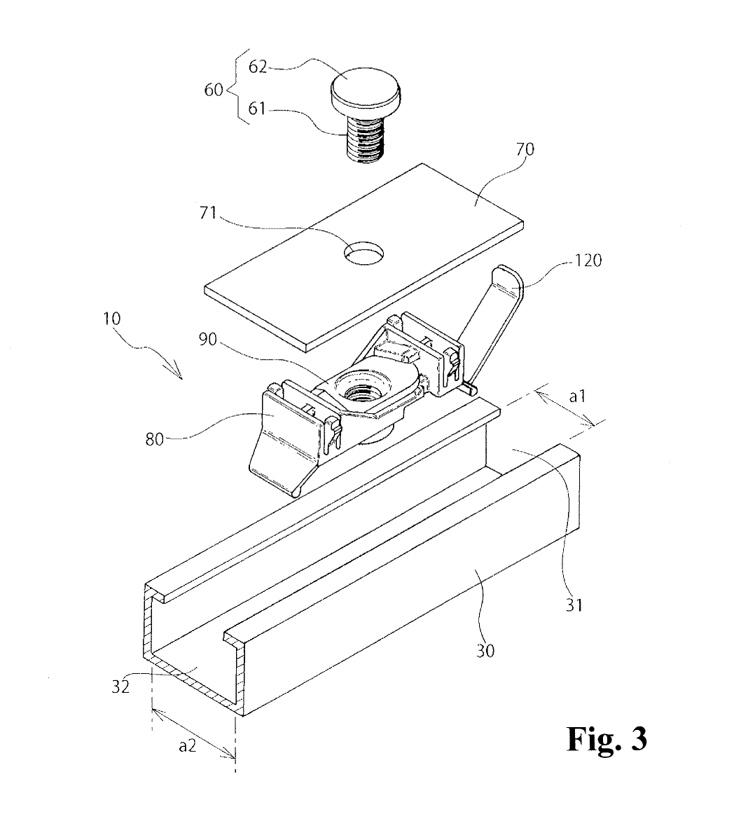

On the other hand, as shown in FIG. 3, the C-shaped steel 30 is formed in an approximately C shape in cross-section, and is structured by a long steel material having cross-section with a shape such that an alphabetical “C” has been crushed in a square shape by slightly folding an opening portion 31 of a groove-shaped steel (a channel) inward. The C-shaped steel 30 includes the opening portion 31 on an upper surface, and includes a hollow portion 32 on the inside. Then, a width a2 of the inside of the hollow portion 32 is wider than a width a1 of the opening portion 31 of the C-shaped steel 30.

As shown in FIG. 3, between the C-shaped steel 30 and the fastening tool 10, there comprise a bolt 60 including a male screw portion which is screwed into the later-mentioned nut 90 of the fastening tool 10; and an attaching plate 70 including the later-mentioned through hole 71 in which an axis portion 61 of the bolt 60 passes.

As shown in FIG. 3, the bolt 60 is made from metal, includes the male screw portion, and includes the axis portion 61 passing the later-mentioned through hole 71 of the attaching plate 70; and a head portion 62 having an outer diameter larger than an inner diameter of the through hole 71.

Incidentally, although the metallic bolt 60 is illustrated as an example, it is not limited to the above, and may be a resin bolt 60.

As shown in FIG. 3, the attaching plate 70 is for attaching the solar cell modules 40, and is made from metal, and the through hole 71 passes through top and bottom surfaces in a circle shape.

Incidentally, although the metallic attaching plate 70 is illustrated as an example, it is not limited to the above, and may be a resin attaching plate 70.

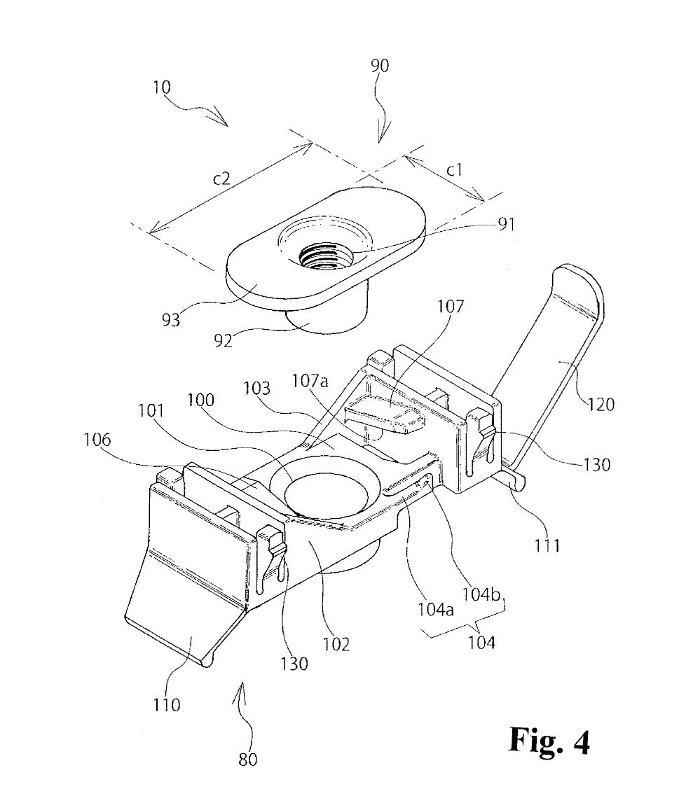

As shown in FIG. 4, the fastening tool 10 roughly comprises the following parts.

Incidentally, the following (1) and (2) will be described later.

(1) Base portion 80

(2) Nut 90

Incidentally, the parts of the fastening tool 10 are not limited to the aforementioned (1) and (2).

### Base Portion 80

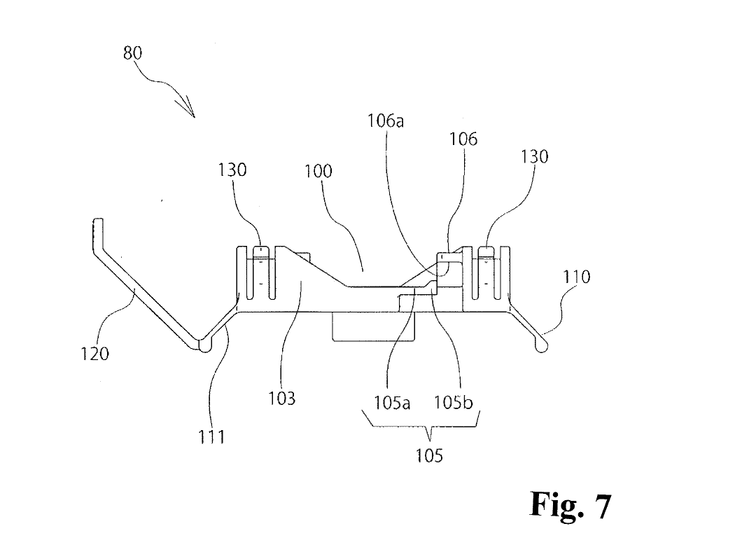

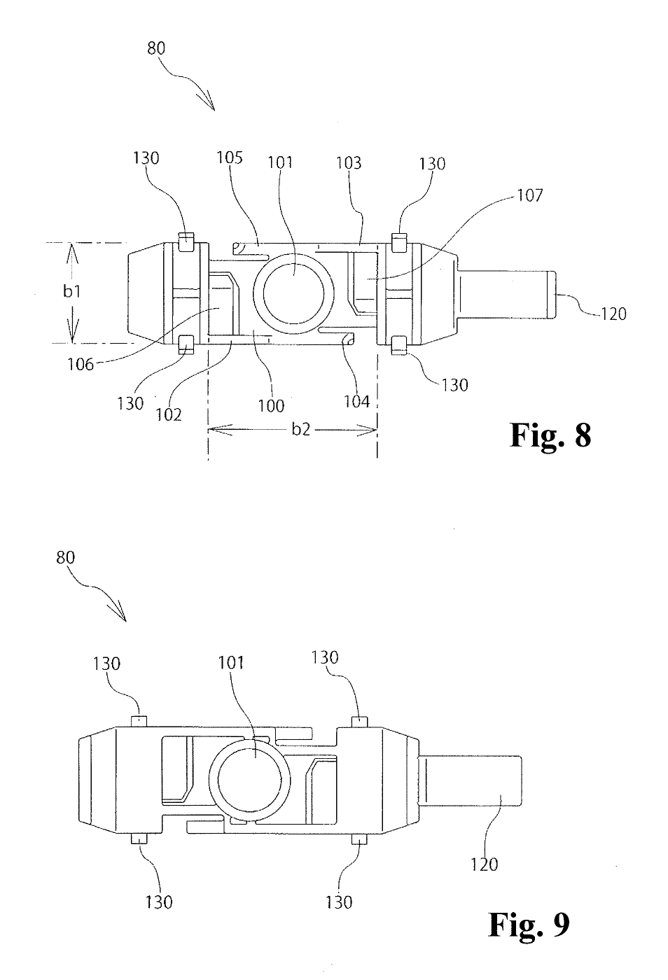

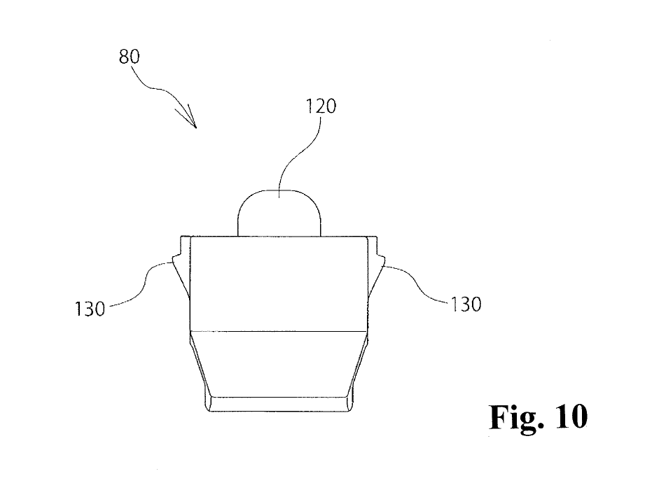

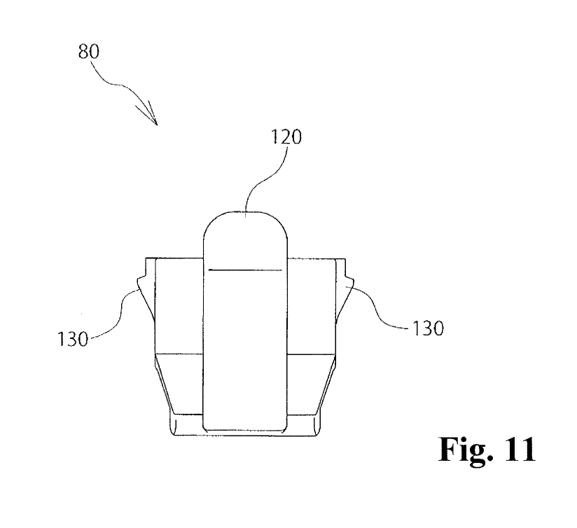

As shown in FIGS. 1, 3 to 5, and 6 to 11, the base portion 80 is inserted from the opening portion 31 of the C-shaped steel 30, and a short side b1 is shorter than a width a1 of the opening portion 31. The base portion 80 is integrally formed by resin having an appropriate amount of elasticity and rigidity.

Specifically, as shown in FIGS. 4 and 6 to 11, the base portion 80 roughly comprises the following respective portions.

Incidentally, the following (1) to (4) will be described later.

(1) Nut holding portion 100

(2) Elastic legs 110 and 111

(3) Operation grip 120

(4) Locking claws 130

Incidentally, each portion of the base portion 80 is not limited to the aforementioned (1) to (4).

### Nut 90

As shown in FIG. 4, the nut 90 includes the base portion 80, and a female screw portion 91 rotatably supported in the base portion 80 in an inner circumference. The nut 90 is made from metal as with the bolt 60. Incidentally, although the metallic nut 90 is illustrated as an example, it is not limited to the above, and may be a resin nut 90.

As shown in FIGS. 3, 4, and 13, the nut 90 is formed to have a short side c1 that is shorter than the width a1 of the opening portion 31, and a long side c2 that is longer than the width a1 of the opening portion 31.

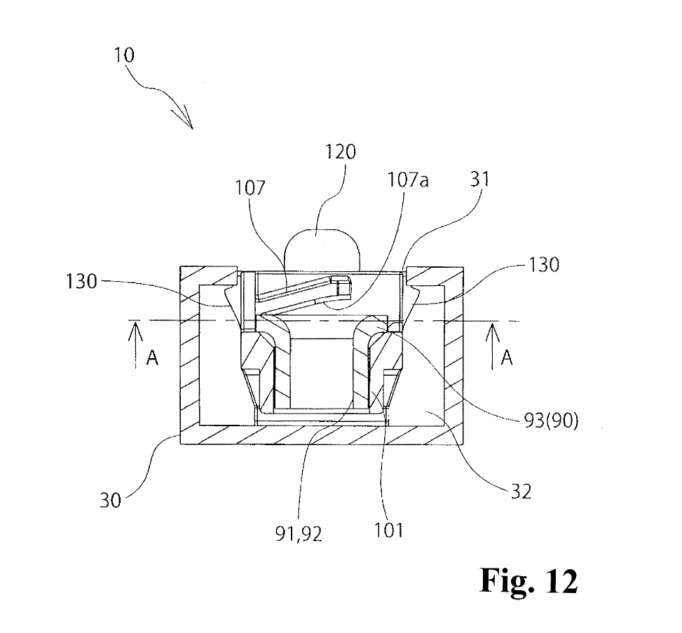

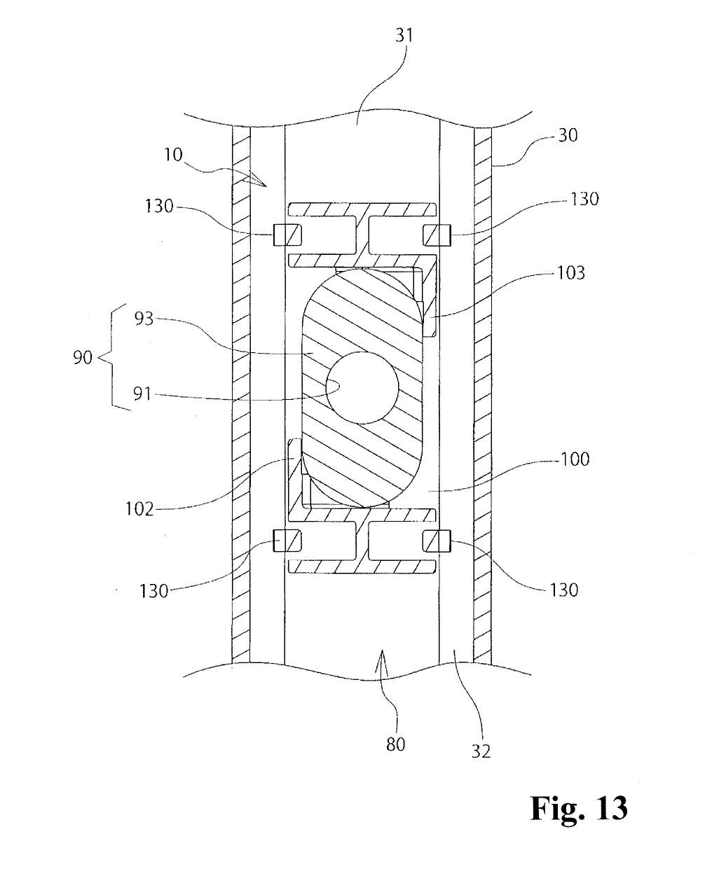

In addition to that, as shown in FIGS. 3 and 13, the nut 90 is inserted into the hollow portion 32 inside the C-shaped steel 30 in a mounting position (see FIGS. 12 and 13) wherein the short side c1 corresponds to the short side b1 of the base portion 80 by inserting the base portion 80 from the opening portion 31.

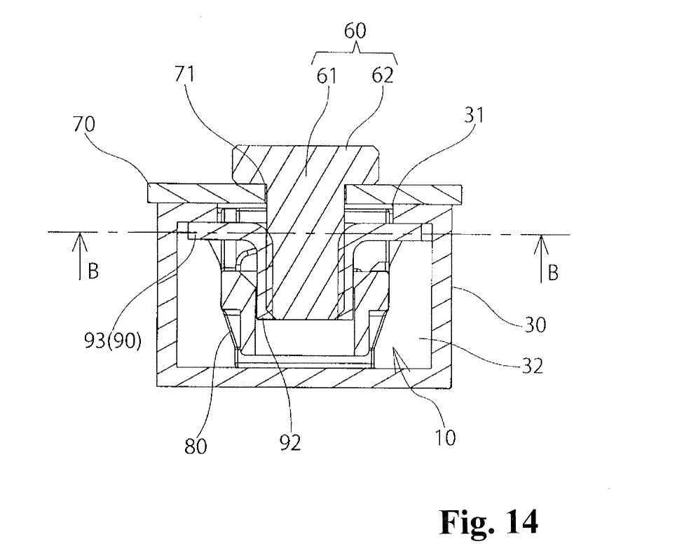

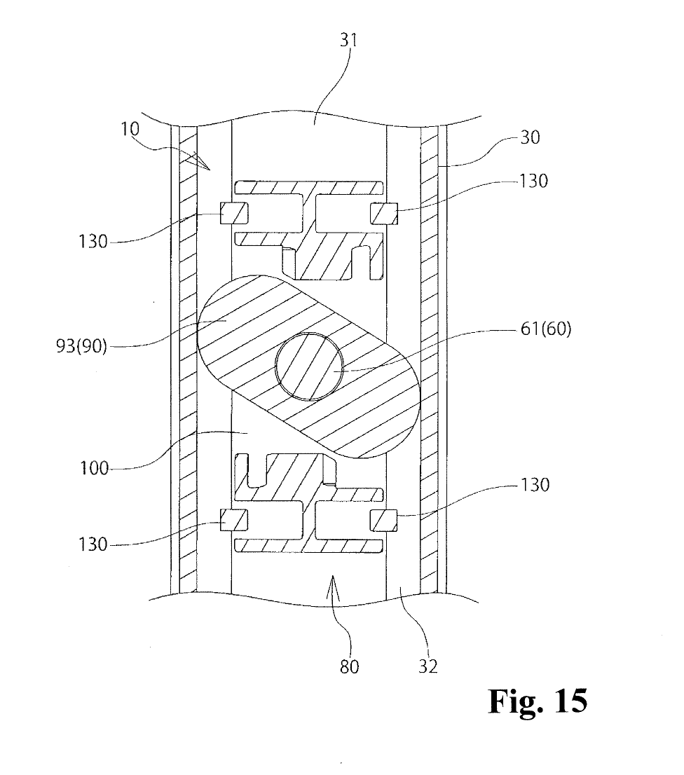

Moreover, as shown in FIG. 15, the axis portion 61 of the bolt 60, which has been inserted from the opening portion 31, is screwed in, and also the nut 90 rotates inside the hollow portion 32, so that the long side c2 intersects with the opening portion 31. Accordingly, the nut 90 reaches a fixed position (see FIGS. 14 and 15) wherein the nut 90 cannot be pulled out from the opening portion 31, and is fixed into the hollow portion 32 through the bolt 60.

Specifically, as shown in FIG. 4, the nut 90 roughly comprises the following respective portions.

Incidentally, the following (1) and (2) will be described later.

(1) Nut main body 92

(2) Flange portion 93

Incidentally, each portion of the nut 90 is not limited to the above-mentioned (1) and (2).

### Nut Main Body 92

As shown in FIG. 4, the nut main body 92 is formed in a cylinder shape, and includes the female screw portion 91 in the inner circumference.

Also, an outer circumference of the nut main body 92 is set in a size of an inner diameter of a support hole 101 of the later-mentioned base portion 80 or less.

### Flange Portion 93

As shown in FIG. 4, the flange portion 93 projects from an upper portion of the nut main body 92 in a non-circular shape, for example, whose flat surface has an oval shape, and an outer circumference is set larger than the inner diameter of the later-mentioned support hole 101. As shown in FIGS. 4 and 13, in the flange portion 93, the short side c1 is set to be shorter than the width a1 of the opening portion 31 of the C-shaped steel 30. Also, the long side c2 of the flange portion 93 is set to be longer than the width a1 of the opening portion 31, and to be longer than the width a2 of the inside of the hollow portion 32 inside the C-shaped steel 30.

### Nut Holding Portion 100

As shown in FIGS. 4, and 6 to 9, the nut holding portion 100 is formed in a concave shape in which the flange portion 93 of the nut 90 is fitted in, and is for rotatably holding the nut 90. As shown in FIGS. 4, 6 to 9, and 12, the short side b1 of the nut holding portion 100 is set to be shorter than the width a1 of the opening portion 31, and to be approximately equal to the short side c1 of the flange portion 93. The long side b2 of the nut holding portion 100 is set in a size of the long side c2 of the flange portion 93 or above, for example, is set to be nearly equal to the long side c2 of the flange portion 93.

Specifically, as shown in FIGS. 4, and 6 to 9, the nut holding portion 100 roughly includes the following respective portions.

Incidentally, the following (1) to (4) will be described later.

(1) Support hole 101

(2) Side wall portions 102 and 103

(3) Temporary fixing claws 104 and 105

(4) Cam portions 106 and 107

Incidentally, each portion of the nut holding portion 100 is not limited to the above-mentioned (1) to (4).

### Support Hole 101

As shown in FIGS. 4, 8, and 9, in the support hole 101, there is fitted the nut main body 92 of the nut 90. The support hole 101 is positioned in the center of the nut holding portion 100, and passes through up and down. The inner diameter of the support hole 101 is set in a size of an outer diameter of the nut main body 92 or above, for example, is set to be nearly equal to the outer diameter of the nut main body 92.

### Side Wall Portions 102 and 103

As shown in FIGS. 1, 4, 6 to 8, and 13, the side wall portions 102 and 103 are for blocking a rotation of the nut 90 in one direction.

Specifically, the side wall portions 102 and 103 respectively protrude upwardly from both sides in a direction of the short side b1 of the nut holding portion 100. The side wall portions 102 and 103 have a length of half or less of the long side b2 of the nut holding portion 100, are alternately formed back and forth in a direction of the long side b2, and abut against an outside surface positioned in a direction of the short side c1 of the flange portion 93 so as to block the rotation of the nut 90 in one direction. On the other hand, when the nut 90 attempts to rotate in a direction opposite to one direction, the nut 90 passes through one-half-portions, which do not have the side wall portions 102 and 103, so that the side wall portions 102 and 103 allow the rotation of the nut 90.

Incidentally, although the side wall portions 102 and 103 are provided with two pieces, they are not limited to the above, and the side wall portions 102 and 103 may be provided with a singular number or three pieces or above.

### Temporary Fixing Claws 104 and 105

As shown in FIGS. 1, 4, and 6 to 8, the temporary fixing claws 104 and 105 are for temporarily fixing the nut 90 in the mounting position.

Specifically, the temporary fixing claws 104 and 105 are on both sides in the direction of the short side b1 of the nut holding portion 100, and elastically protrude upwardly from the one-half-portions which do not have the side wall portions 102 and 103. The temporary fixing claws 104 and 105 face the respective side wall portions 102 and 103 in the direction of the short side b1 of the nut holding portion 100. The temporary fixing claws 104 and 105 include elastic pieces 104a and 105a extending long in the direction of the long side b2 of the nut holding portion 100; and protrusions 104b and 105b protruding upwardly from free end portions of the elastic pieces 104a and 105a. Outside surfaces of the protrusions 104b and 105b facing the nut 90 are sloped, and when the bolt 60 is screwed into the nut 90, and rotates, the outside surfaces of the protrusions 104b and 105b are pressed by the flange portion 93, and bend downwardly so as to retract.

Incidentally, although the temporary fixing claws 104 and 105 are provided with two pieces, they are not limited to the above, and may be provided with a singular number or three pieces or above.

### Cam Portions 106 and 107

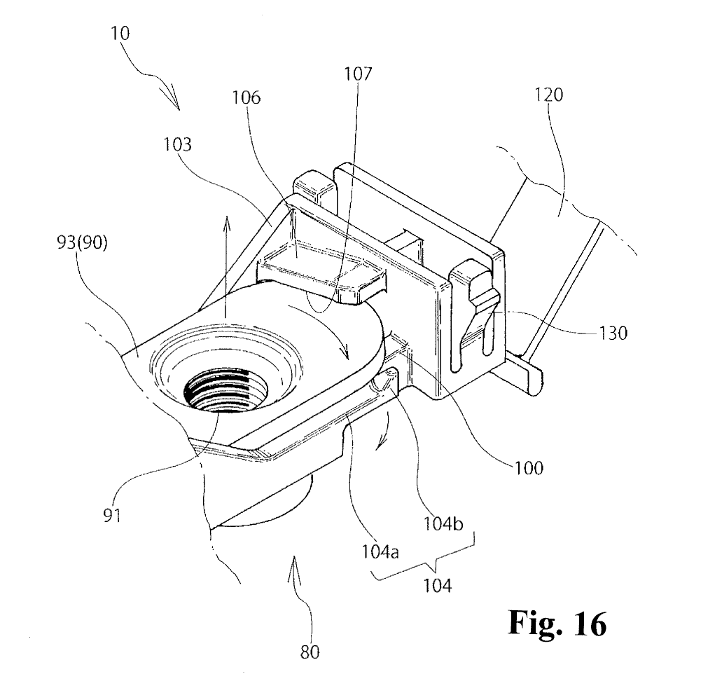

As shown in FIGS. 1, 4, 6 to 8, and 16, the cam portions 106 and 107 include cam slope faces 106a and 107a rotating the nut 90 inside the hollow portion 32 of the C-shaped steel 30 when the nut 90 moves in an axial direction of the bolt 60 by screwing the bolt 60.

Specifically, the cam portions 106 and 107 protrude in a piece-like manner upwardly away from a bottom of the nut holding portion 100.

The cam slope faces 106a and 107a are positioned on lower surfaces facing the bottom of the nut holding portion 100, and slope upwardly toward one of the temporary fixing claws 104 and 105.

Incidentally, although the cam portions 106 and 107 are provided with two pieces, they are not limited to the above, and the cam portions 106 and 107 may be provided in one portion or three portions or above.

### Elastic Legs 110 and 111

As shown in FIGS. 1, 4, 6, and 7, the elastic legs 110 and 111 are respectively positioned on both sides in the direction of the long side b2 of the nut holding portion 100, and elastically extend toward a bottom of the hollow portion 32 of the C-shaped steel 30.

Specifically, the elastic legs 110 and 111 obliquely slope downwardly in such a way as to outwardly extend to the long side b2 of the nut holding portion 10 toward the bottom of the hollow portion 32.

Incidentally, although the elastic legs 110 and 111 are provided as a pair, they are not limited to the above, and may be provided with a singular number or three pieces or above.

### Operation Grip 120

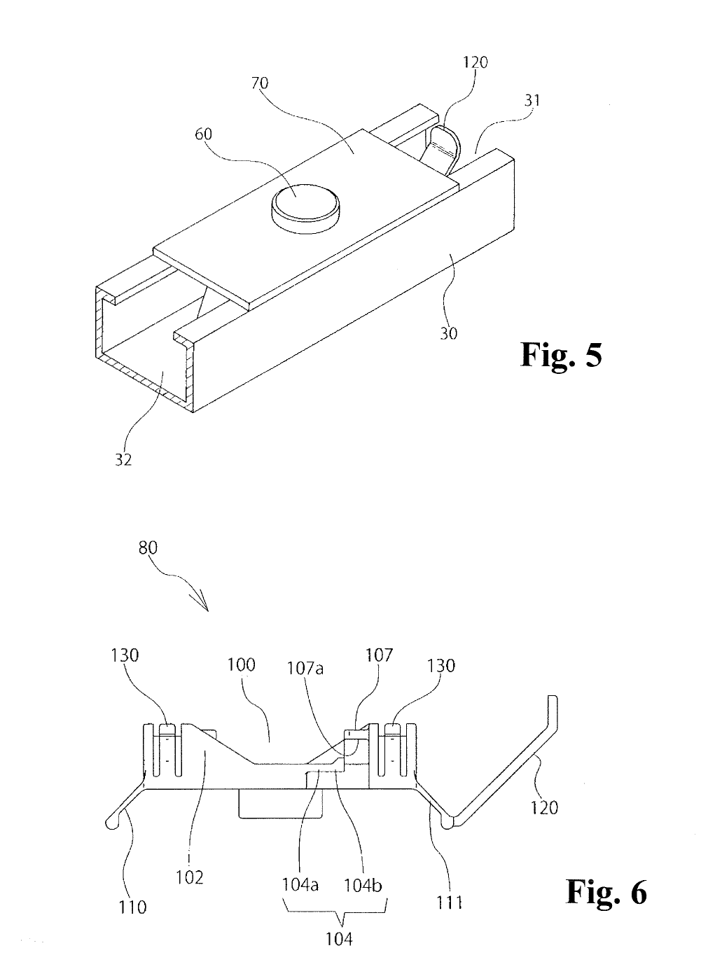

As shown in FIG. 5, the operation grip 120 faces the opening portion 31 in a state wherein the base portion 80 is inserted into the hollow portion 32 of the C-shaped steel 30.

Specifically, the operation grip 120 extends by being bent in a V shape in cross-section from one elastic leg 111 of the elastic legs 110 and 111. As shown in FIG. 5, the operation grip 120 protrudes upwardly from the opening portion 31 in the state wherein the base portion 80 is inserted into the hollow portion 32 of the C-shaped steel 30.

Incidentally, although the operation grip 120 is provided in one elastic leg 111 of the elastic legs 110 and 111, it is not limited to the above, and the operation grip 120 may be provided on both of the elastic legs 110 and 111, or be provided only in the other elastic leg 110, or be provided in the other portion of the base portion 80. Also, although the operation grip 120 is provided with one piece, it is not limited to the above, and a plurality of operation grips 120 may be provided. Moreover, although the operation grip 120 protrudes upwardly from the opening portion 31, it is not limited to the above, and the operation grip 120 may face the opening portion 31, or be receded from the opening portion 31. In that case, the operation grip 120 may slide by inserting fingers, a jig, or the like from the opening portion 31.

### Locking Claws 130

As shown in FIGS. 1, 4, 6 to 11, and 12, the locking claws 130 are formed in outside surfaces of the base portion 80, and lock at an opening edge of the opening portion 31 of the C-shaped steel 30.

Specifically, the locking claws 130 respectively protrude outwardly from the outside surfaces of right and left in a direction of the short side b1 of the base portion 80; are disposed in four directions; and are provided with a total of four pieces. The locking claws 130 inwardly bend by being pressed by an inner edge of the opening portion 31 when the locking claws 130 pass the opening portion 31 so as to pass the opening portion 31. The locking claws 130 prevent the base portion 80 from escaping from the opening portion 31 by elastically restoring to original state after passing the opening portion 31.

Also, at that time, due to the elastic legs 110 and 111, the base portion 80 is elastically pressed up toward the opening portion 31, so that the locking claws 130 elastically abut against inner surfaces on both sides of the opening portion 31 so as to prevent the base portion 80 from moving in a longitudinal direction of the C-shaped steel 30.

Incidentally, although the locking claws 130 are provided with four pieces, they are not limited to the above, and may be provided with one, two pieces, three pieces, or five pieces or above.

### Attaching Method of Fastening Tool 10

Next, with a usage of the fastening tool 10 with the aforementioned structure, an attaching method fixing the attaching plate 70 for attaching the solar cell modules 40, which are the mating members, relative to the C-shaped steels 30, which are the structures, by using the bolt 60, will be explained.

### Assembly of Fastening Tool 10

First, as shown in FIGS. 1 and 4, the nut 90 is fitted in to conform to the nut holding portion 100 of the base portion 80, and the fastening tool 10 is assembled.

Namely, the nut main body 92 of the nut 90 is fitted in to conform to the support hole 101 of the nut holding portion 100. Incidentally, at that time, the flange portion 93 prevents interference with the cam portions 106 and 107 of the nut holding portion 100 by fitting the nut main body 92 in a position wherein the short side c1 of the flange portion 93 and the short side b1 of the nut holding portion 100 intersect.

Next, the nut 90 is rotated in a direction wherein the short side c1 of the flange portion 93 of the nut 90 and the short side b1 of the nut holding portion 100 correspond, i.e., counterclockwise in FIG. 1.

When the nut 90 is rotated, the flange portion 93, and the temporary fixing claws 104 and 105 of the nut holding portion 100 abut.

Here, when the flange portion 93 is strongly rotated, the temporary fixing claws 104 and 105 are pressed by a lower surface of the flange portion 93, and bond downwardly, so that the flange portion 93 passes.

The flange portion 93 abuts against the side wall portions 102 and 103 of the nut holding portion 100, so that a rotation of the flange portion 93 halts. At that time, the temporary fixing claws 104 and 105 restore to the original state, and elastically hold the flange portion 93 between the side wall portions 102 and 103, and the temporary fixing claws 104 and 105 so that the flange portion 93 does not rotate abruptly. Also, the flange portion 93 is fitted in a lower side of the cam portions 106 and 107.

### Temporary Fixture of Fastening Tool 10 into C-Shaped Steel 30

Next, as shown in FIGS. 3, 5, 12, and 13, the fastening tool 10 which has been assembled is inserted to conform to the opening portion 31 of the C-shaped steel 30, so that the fastening tool 10 is temporarily fixed to the C-shaped steel 30.

Namely, with a direction wherein the width a1 of the opening portion 31 and the short side b1 of the base portion 80 of the fastening tool 10 correspond, the base portion 80 is inserted from above to conform to the opening portion 31. When the base portion 80 is inserted, the locking claws 130 protruding outwardly in the direction of the short side b1 of the base portion 80 abut against the inner edge of the opening portion 31.

Here, when the base portion 80 is pressed strongly, the locking claws 130 inwardly bend by being pressed by the inner edge of the opening portion 31 so as to pass the opening portion 31. The locking claws 130 elastically restore to original state after passing the opening portion 31 so as to prevent the base portion 80 from escaping from the opening portion 31.

Also, at that time, due to the elastic legs 110 and 111, the base portion 80 is elastically pressed up toward the opening portion 31, so that the locking claws 130 elastically abut against the inner surfaces on both sides of the opening portion 31 so as to prevent the base portion 80 from moving in the longitudinal direction of the C-shaped steel 30.

Moreover, as shown in FIG. 5, the operation grip 120 of the base portion 80 protrudes upwardly from the opening portion 31. Consequently, by griping the operation grip 120, and sliding the base portion 80 along the longitudinal direction of the C-shaped steel 30, positioning of an attachment of the later-mentioned attaching plate 70 can be carried out.

### Attachment of Attaching Plate 70 to C-Shaped Steel 30

Next, as shown in FIGS. 3, 5, 14, and 15, with a usage of the fastening tool 10 attached to the C-shaped steel 30, the attaching plate 70 is attached relative to the C-shaped steel 30.

First, as shown in FIG. 3, the axis portion 61 of the bolt 60 is passed through the through hole 71 of the attaching plate 70. The axis portion 61 protruding from the through hole 71 is passed through the opening portion 31 of the C-shaped steel 30, is inserted to conform to the female screw portion 91 of the nut 90 of the fastening tool 10, and is screwed in.

When the bolt 60 is screwed in, the nut 90 ascends toward the opening portion 31. At that time, due to the abutment between the nut 90 and the cam slope faces 106a and 107a of the cam portions 106 and 107, the flange portion 93 of the nut 90 rotates clockwise in FIG. 1.

As shown in FIG. 15, the flange portion 93 abuts against inside surfaces of right and left orienting in a direction of the width a2 of the hollow portion 32 of the C-shaped steel 30, so that the rotation is blocked.

In a state wherein the rotation of the flange portion 93 is blocked, when the nut 90 is tightened strongly, the nut 90 ascends inside the hollow portion 32, and abuts against an inner surface which is located in an outer edge of the opening portion 31. Accordingly, four pieces of the metallic components of the nut 90, the C-shaped steel 30, the attaching plate 70, and the head portion 62 of the bolt 60 closely contact mutually, and the attaching plate 70 is fixed relative to the C-shaped steel 30.

### Second Embodiment

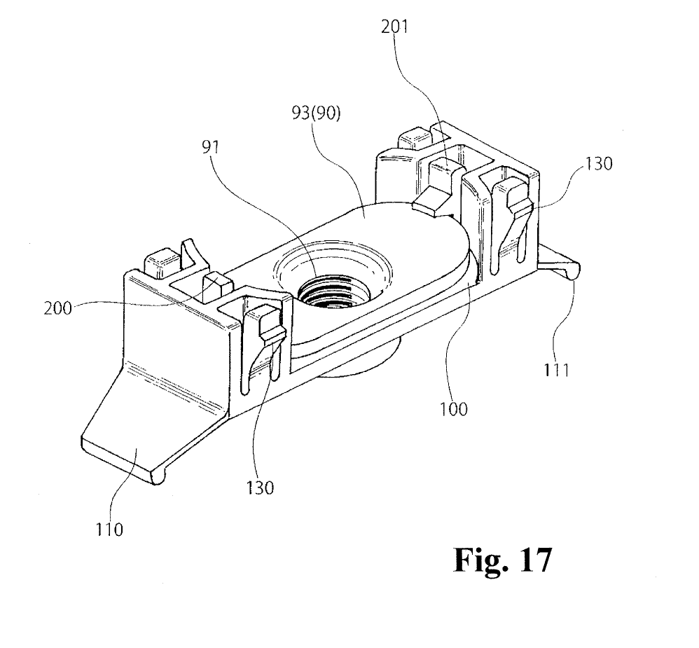

Next, with FIG. 17, a second embodiment of the present invention will be explained.

As shown in FIG. 17, a characteristic of the present embodiment is that temporary fixing claws 200 and 201 are disposed on both sides in the direction of the long side b2 of the nut holding portion 100 of the base portion 80, and also that the cam portions 106 and 107, including the cam slope faces 106a and 107a, of the first embodiment which has been previously explained with FIGS. 1 to 16, are omitted.

First, as shown in FIG. 17, the temporary fixing claws 200 and 201 engage an upper end portion of the nut 90, and temporarily fix the nut 90 between the temporary fixing claws 200 and 201, and the bottom of the nut holding portion 100.

Secondly, the cam portions 106 and 107 including the cam slope faces 106a and 107a of the first embodiment are omitted, and by using the nut 90 which rotates together with the bolt 60 when the bolt 60 is screwed in, the nut 90 is rotated.

Incidentally, in an explanation of the present embodiment, the same symbols are assigned to the same structural portions as those of the first embodiment which has been previously explained with FIGS. 1 to 16, and their explanations are omitted.

### Third Embodiment

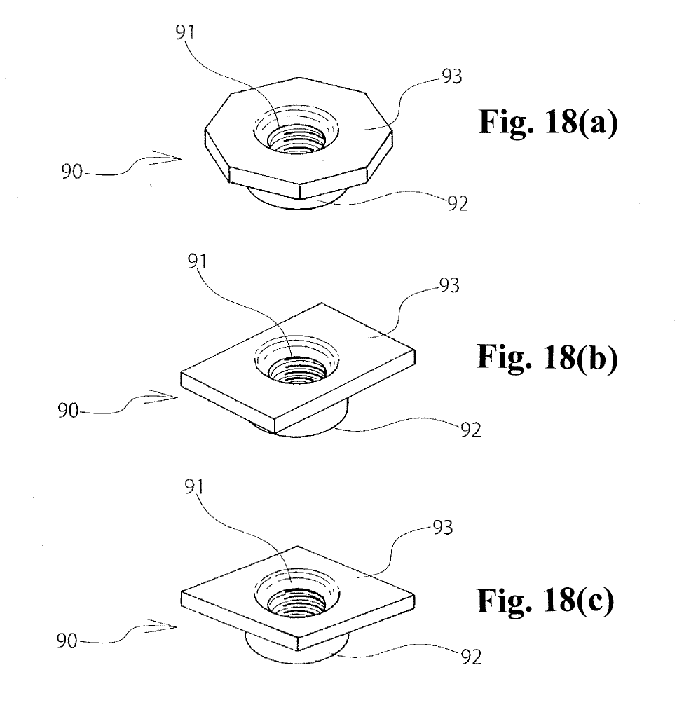

Next, with FIGS. 18(a) to 18(c), a third embodiment of the present invention will be explained.

As shown in FIGS. 18(a) to 18(c), a characteristic of the present embodiment is that a modified example of the flange portion 93 of the nut 90 is shown.

Namely, in FIG. 18(a), a flat surface of a flange portion 300 is formed in an octagon shape. In FIG. 18(b), the flat surface of the flange portion 300 is formed in a rectangle shape. In FIG. 18(c), the flat surface of the flange portion 300 is formed in a parallelogram shape.

Incidentally, in the first embodiment which has been previously explained with FIGS. 1 to 16, the flat surface of the flange portion 93 is formed in the oval shape, and in the present embodiment in FIGS. 18(a) to 18(c), the flat surfaces are formed in the octagon shape; in the rectangle shape; and in the parallelogram shape. However, the shapes of the flat surfaces of the flange portion 93 are not limited to the above provided that the shapes of the flat surfaces are a non-circular shape having a different length of a long side and a short side.

Incidentally, in the explanation of the present embodiment, the same symbols are assigned to the same structural portions as those of the first embodiment which has been previously explained with FIGS. 1 to 16, and their explanations are omitted.

### Fourth Embodiment

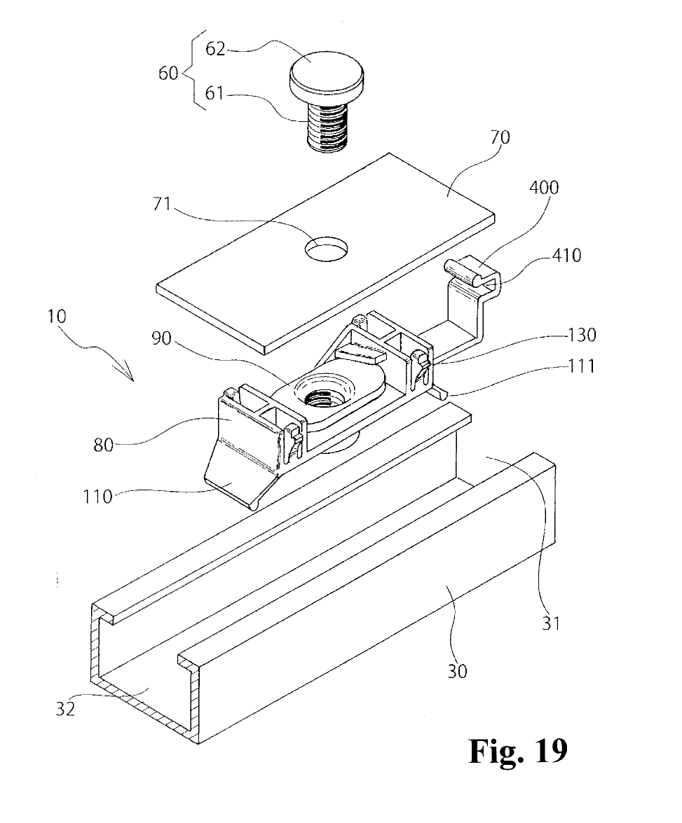

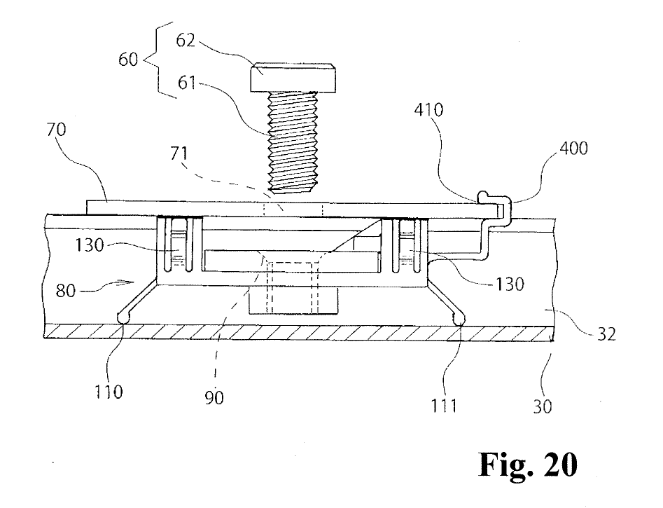

Next, with FIGS. 19 and 20, a fourth embodiment of the present invention will be explained.

As shown in FIGS. 19 and 20, a characteristic of the present embodiment is that the attaching plate 70 can be held using an operation grip 400.

Namely, as shown in FIGS. 19 and 20, an end portion of the operation grip 400 is upwardly folded back in a U shape so as to form a plate holding portion 410.

As shown in FIG. 19, the attaching plate 70 is inserted into the plate holding portion 410, and is held in such a way to sandwich the attaching plate 70 using elasticity. When the plate holding portion 410 holds the attaching plate 70, the plate holding portion 410 is set in a size in which the center of the through hole 71 of the attaching plate 70 and the female screw portion 91 of the nut 90, which has been temporarily fixed to the nut holding portion 100 of the base portion 80, corresponds in an up-and-down direction.

According to the present embodiment, in a state wherein the attaching plate 70 is held in the plate holding portion 410, positioning of the center of the through hole 71 of the attaching plate 70 and the female screw portion 91 of the nut 90 can be carried out.

Incidentally, in the explanation of the present embodiment, the same symbols are assigned to the same structural portions as those of the first embodiment which has been previously explained with FIGS. 1 to 16, and their explanations are omitted.

Incidentally, all contents of the specification, claims, drawings, and abstract of Japanese Patent Application No. 2010-028217 filed on Feb. 10, 2010 are cited in their entireties herein and are incorporated as a disclosure of the specification of the present invention.

1. A fastening tool for fixing a mating member to a structure with an approximately C shape in cross section, comprising:
a base portion which is inserted from an opening portion of the structure; and
a nut movably supported in the base portion, and having a female screw portion in an inner circumference,
wherein the nut is formed to have a short side shorter than a width of the opening portion, and a long side longer than the width of the opening portion,
wherein at a mounting position where the short side corresponds to the short side of the base portion, the nut is inserted into a hollow portion inside the structure by inserting the base portion from the opening portion,
wherein a male screw portion, which has been inserted from the opening portion, is screwed in,
wherein when the nut rotates inside the hollow portion, the long side intersects with the opening portion, so that the nut reaches a fixed position which cannot be pulled out from the opening portion, and is fixed into the hollow portion through the male screw portion, and
wherein the base portion includes a temporary fixing claw temporarily fixing the nut in the mounting position.

2. A fastening tool according to claim 1, wherein the temporary fixing claw is an elastic claw.

3. A fastening tool according to claim 1, wherein between the base portion and the nut, a cam slope face, which rotates the nut inside the hollow portion of the structure when the nut has moved in an axial direction of the male screw portion by screwing the male screw portion, is provided.

4. A fastening tool according to claim 1, further comprising a locking claw locking in an opening edge of the opening portion of the structure on an outside surface of the base portion.

5. A fastening tool according to claim 1, wherein the base portion includes an operation grip facing the opening portion in a state wherein the base portion is inserted into the hollow portion of the structure.
